(19) United States
(12) Patent Application Publication
(10) Pub. No.: US 2008/0230014 A1
(43) Pub. Date: Sep. 25, 2008

(54) PORTABLE DOG OPERABLE BELL ASSEMBLY AND METHOD FOR POTTY TRAINING DOGS

(76) Inventor: Mary Ann Oakes, Alpharetta, GA (US)

Correspondence Address: HAHN LOESER & PARKS, LLP, One GOJO Plaza, Suite 300, AKRON, OH, 44311-1076, US

(21) Appl. No.: 12/052,794

(22) Filed: Mar. 21, 2008

Related U.S. Application Data
(60) Provisional application No. 60/896,538, filed on Mar. 23, 2007.

(51) Int. Cl. A01K 15/02

(52) U.S. Cl. 119/719

(57) ABSTRACT

This invention relates to a dog operable bell assembly and a method for potty training dogs, and more particularly, the invention relates to a portable bell device suited for operation by a dog that permits a dog to “tell” his owner when he needs to go outside to urinate and/or defecate.

This utility patent application claims priority to U.S. provisional patent application Ser. No. 60/896,538 filed on Mar. 23, 2007.

### TECHNICAL FIELD

This invention relates to a dog operable bell assembly and a method for potty training dogs, and more particularly, the invention relates to a portable bell device suited for operation by a dog that permits a dog to “tell” his owner when he needs to go outside to urinate and/or defecate (hereinafter “going potty” except as used in the claims and summary) and a method for training the dog to use the portable bell device.

### BACKGROUND OF THE INVENTION

Many prior art bell devices exists for use by a dog, however, each of the devices suffers from at least one disadvantage. Many of the prior art devices are electrically wired which means that the device cannot be moved to other doors in the house, or used when traveling to other houses, hotels, etc.

Another prior art bell device comprises one or more bells that hang from a tether attached to a door knob. One problem with this device is that the bells ring whenever the door is opened which can become a nuisance. The constant ringing can prevent a dog from associating the sound with going outside. Another problem is that a hanging device on a door still requires the dog to put its paws in the air to ring the device, resulting in marks on the doors and walls.

### BRIEF SUMMARY

In one embodiment, a method of training a dog to signal a person that the dog needs to go outdoors to urinate and/or defecate includes the steps of (a.) providing a manually actuatable device that produces an audible sound, (b.) forcing the dog to actuate the manually actuatable device, and (c.) taking the dog outside to urinate and/or defecate.

In one aspect of the embodiments of the subject invention, after the step of taking the dog outside to urinate and/or defecate, another step includes verbally affirming the dog.

In another aspect of the embodiments of the subject invention, the step of verbally affirming the dog includes repeating the dog's name and verbally praising the dog.

In yet another aspect of the embodiments of the subject invention, another step includes placing the manually actuatable device near an entrance or exit of an associated structure.

In still another aspect of the embodiments of the subject invention, the audible sound is a single tone audible sound.

In even another aspect of the embodiments of the subject invention, the manually actuatable device is a mechanically actuatable bell.

In another aspect of the embodiments of the subject invention, another step includes repeating steps (a.) through (c.) until the dog intuitively actuates the manually actuatable device when the dog has to urinate and/or defecate without forcing the dog to actuate the manually actuatable device.

In another aspect of the embodiments of the subject invention, another step includes immediately taking the dog indoors after the dog has urinated and/or defecated.

In one embodiment of the subject invention, a dog-operable manually actuatable device, includes a base, means for creating a dog-audible tone operatively attached to the base, and an actuator in operative communication with said means for creating a dog-audible tone.

In another aspect of the embodiments of the subject invention, said means for creating a dog-audible tone is a bell.

In still another aspect of the embodiments of the subject invention, the device includes a hammer operatively attached to the base, and wherein the actuator comprises a plunger having a plunger head.

In yet another aspect of the embodiments of the subject invention, the plunger head is at least 0.85 inch diameter.

### BRIEF DESCRIPTION OF THE DRAWINGS

This invention will now be described in further detail with reference to the accompanying drawings, in which:

FIG. 1 shows a side elevational view of the bell assembly apparatus of the present invention;

FIG. 2 is a bottom view of the bell assembly apparatus of FIG. 1;

FIG. 3 is a partial cross-sectional view of the bell assembly apparatus of FIG. 1 showing the plunger and the lever positioned in relation to the bell and the base; and

FIG. 4 is a top view of the bell assembly apparatus of FIG. 1.

### DETAILED DESCRIPTION OF THE INVENTION

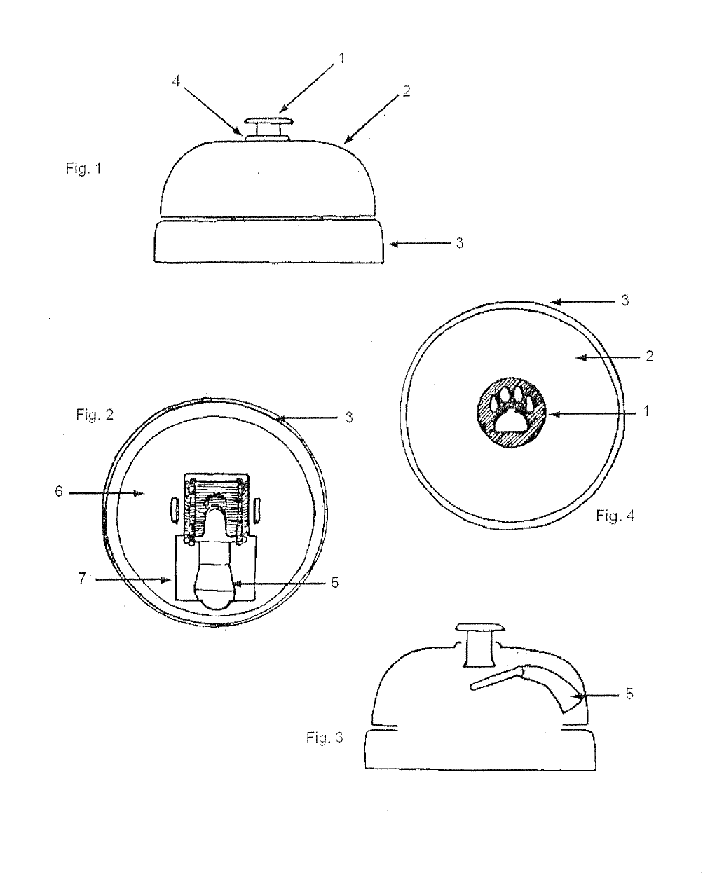

Referring now to FIGS. 1-4, an embodiment of the bell assembly 10 of the present invention is shown. The bell assembly 10 comprises a plunger 1, a bell 2, and a base 3. The bell 2 is supported by the base 3 and attached thereto by a snap bushing 4. A lever 5 is pivotally attached to the base 3 such that downward movement of plunger 1 causes the lever 5 to pivot such that a hammer portion of the lever 5 strikes the interior surface of the bell 2, causing the bell 2 to ring. The lever 5 is shown positioned in an opening 7 in the bottom surface 6 of the base in FIG. 2 and in the partial cross-sectional view of FIG. 3. The hammer portion of the lever 5 is enlarged so that the weight of hammer end of the lever 5 causes the lever 5 to pivot away from the bell 2 such that the opposite end of the lever 5 pushes the plunger 1 upward into its original position after the bell 2 has been rung. The bell 2 is typically made of nickel plated steel and has a generally hemispherical shape; however, the bell 2 is not limited herein to any particular material or shape. The plunger 1, base 3, bushing 4, and lever 5 are typically made of plastic; however, these components are not intended to be limited herein to any particular material. The head of the plunger 1 is oversized in comparison to a standard call bell. The plunger head should be at least 0.85 inch in diameter to accommodate the paw of a dog.

In one embodiment of the invention, a method is provided for training a dog to use the bell assembly 10 of the present invention. A first step involves determining the location for placement of the bell assembly 10. The initial training may use a single bell assembly 10 until the dog has been trained to associate the bell assembly 10 with going outdoors to potty. The bell assembly 10 is typically placed near a door that is easy to go in and out of and is near the area outside where you want the dog to go potty. A door off the kitchen area is typically a preferred choice. While the dog may be shown the bell assembly 10, it is a training device and the dog should never be allowed to play with the bell assembly 10.

Another step of the training method of the present invention is determining the location outside where the dog will go potty. It is best to pick the same area of the yard or mulch for the dog to repeatedly go potty as opposed to a different location each time. Dogs desire to have their own area, and will usually sniff to confirm ownership before going potty. (This is true in the home as well, making the thorough cleaning of any accidents in the home by the dog important.)

The training begins by teaching the dog to ring the bell assembly 10 every time before going outside to potty. This is done by placing the dog's paw on top of the plunger 1 and pressing down until the bell 2 rings. The muzzle of the dog should not be used as the paw works better. Even if the dog is being held, the trainer should bend down and make sure the dog rings the bell assembly 10 with his paw. If the dog being trained is a puppy, he will need to go potty about every 1-2 hours, especially after playing, eating or drinking, and napping. If the dog is an adult dog, then the owner likely knows the dog's routine.

After the dog has rung the bell assembly 10, the dog is ready to be taken outside. Use a leash on the dog when taking him out even if the home has a fenced yard. The dog will not associate the bell assembly 10 with going potty if the dog can run around in a fenced yard. After the dog is bell trained, then the owner/trainer can let him out in the fenced yard after ringing the bell assembly 10. The trainer will give a command to the dog like “hurry up” or “go ahead”. The command should be repeated frequently, along with the dog's name, until the dog goes potty. The trainer should try to keep the dog outside until the dog goes potty. If the dog does not go potty after 5-10 minutes, then the trainer should take the dog inside for 15 minutes, keeping close to the dog, before taking the dog back out to try again. Again, the trainer ensures that the dog rings the bell assembly 10, by placing the dog's paw on it. The process consists of taking your dog outside till he goes.

After the dog goes potty, the trainer should be affectionate with the dog by providing pats and rubs to the dog along with telling the dog “good boy” or “good girl” or “good job” along with the dog's name. Saying the dog's name frequently will help ensure that the dog associates positive feedback with going potty. The dog did what the trainer wanted, so the trainer needs to take steps to show the dog that the trainer is happy through visual and audible means. Some trainers recommend giving treats, but this may cause a dog to associate ringing the bell assembly 10 with getting a treat.

When the dog rings the bell assembly 10 independently, the dog is now communicating with the owner/trainer. The owner/trainer should take the dog out immediately and not wait or the dog will not make the connection between the bell assembly 10 and going potty. The trainer should never pat or praise the dog before taking him out, because the excitement may cause the dog to go potty while still in the house. Rather, the trainer/owner should wait and praise the dog after the dog has successfully gone potty outside.

During initial training and afterward, it is important that the person opening the door and allowing the dog outside immediately return the dog to the house after the dog goes potty. The dog should not be taken for a walk or played with after ringing the bell or after going potty. This will help ensure that the dog only associates the bell assembly 10 with going to the restroom. At no other time is the bell assembly 10 to be rung except for going outside for the dog to go potty. Once the dog is “bell assembly trained”, an additional bell assembly 10 can be used at another door. This is helpful for owners having a large home.

Another aspect of the bell assembly is portability as the bell assembly 10 is ideal for traveling. At new locations, the bell assembly 10 is placed by a door to the outside. The bell assembly 10 is shown to the dog while placed near the door.

While this invention has been described with reference to embodiments thereof, it shall be understood that such description is by way of illustration and not by way of limitation. Accordingly, the scope and content of the present invention are to be defined only by the terms of the appended claims.

What is claimed is:

1. A method of training a dog to signal a person that the dog needs to go outdoors to urinate and/or defecate, the method comprising the steps of:
(a.) providing a manually actuatable device that produces an audible sound;
(b.) forcing the dog to actuate the manually actuatable device; and,
(c.) taking the dog outside to urinate and/or defecate.

2. The method as defined in claim 1, wherein after the step of taking the dog outside to urinate and/or defecate, the step further comprising:
verbally affirming the dog.

3. The method as defined in claim 2, wherein the step of verbally affirming the dog includes repeating the dog's name and verbally praising the dog.

4. The method as defined in claim 1, further comprising the step of:
placing the manually actuatable device near an entrance or exit of an associated structure.

5. The method as defined in claim 1, wherein the audible sound is a single tone audible sound.

6. The method as defined in claim 1, wherein the manually actuatable device is a mechanically actuatable bell.

7. The method as defined in claim 1, further comprising the step of:
repeating steps (a.) through (c.) until the dog intuitively actuates the manually actuatable device when the dog has to urinate and/or defecate without forcing the dog to actuate the manually actuatable device.

8. The method as defined in claim 1, further comprising the step of:
immediately taking the dog indoors after the dog has urinated and/or defecated.

9. A dog-operable manually actuatable device, comprising:
a base;
means for creating a dog-audible tone operatively attached to the base; and,
an actuator in operative communication with said means for creating a dog-audible tone;

10. The device as defined in claim 9, wherein said means for creating a dog-audible tone is a bell.

11. The device as defined in claim 10, further comprising:
a hammer operatively attached to the base; and,
wherein the actuator comprises a plunger having a plunger head.

12. The device as defined in claim 11, wherein the plunger head is at least 0.85 inch diameter.
